(19) United States
(12) Patent Application Publication
(10) Pub. No.: US 2012/0184618 A1
(43) Pub. Date: Jul. 19, 2012

(54) TEAT DIP CONCENTRATE

(75) Inventors: Eric D. CARTER, Monroe, WA (US); Joseph P. MORELLI, Bothell, WA (US)

(73) Assignee: ECOLAB USA INC., St. Paul, MN (US)

(21) Appl. No.: 13/347,306

(22) Filed: Jan. 10, 2012

Related U.S. Application Data
(60) Provisional application No. 61/432,357, filed on Jan. 13, 2011.

(51) Int. Cl. A01N 37/36; A01J 7/04; A01P 1/00

(52) U.S. Cl. 514/560; 119/670

(57) ABSTRACT

A concentrated iodine-free teat dip composition is provided including sulfonated oleic acid, a metal chelant, and an aqueous acidulant wherein the diluted use solution has a pH of less than 2.7. A method of treating mastitis is provided including applying the diluted concentrate on an animal's teats. Applying is accomplished by dipping the teats into a liquid solution, spraying the use solution onto the teats, or dipping the teats into or spraying onto the teats a diluted foamed composition of the concentrate.

This application claims priority under 35 U.S.C. §119(e) to U.S. Provisional Application entitled “Teat Dip Concentrate”, Ser. No. 61/432,357 filed on Jan. 13, 2011, which is incorporated herein by reference in its entirety for all purposes.

### BACKGROUND

Milking of cows on a large scale is almost entirely done with a milking machine. The milking machine draws the milk from the cow's udder by pulsating vacuum, e.g., by attaching a teat cup connected to a vacuum pump and pulsating the vacuum to alternately allow the milk to fill and drain from the area of the udder and teat to simulate hand milking of the cow. The tendency is to minimize the milking time by using high vacuum which can cause irritation or damage to the teat and udder.

The damage to tissue caused by the milking machine followed by exposure of the damaged tissue to certain microorganisms can result in an infection known as mastitis. Control of mastitis is of great economic importance to dairy farmers because an infected cow's contaminated milk cannot be marketed. The udder and teats of an infected cow can be treated with an antibiotic to inhibit the spread of mastitis causing pathogens. However, the milk from such cows cannot be sold until the antibiotic is absent from the milk (usually about 3-5 days after the last treatment).

According to experts, prevention of mastitis by the dipping of teats in an antimicrobial (biostatic or biocidal) solution is one of the most effective procedures that a dairy farmer can follow. Application of an antimicrobial solution may be performed before or after milking, or both. An essential function of a teat dip is to prevent mastitis by killing or controlling infectious microorganisms. The teat dip product desirably has a wide spectrum of antibacterial activity (i.e., it can kill or inhibit the growth of a wide variety of mastitis-causing microorganisms), and has emollient properties to prevent irritation of the skin on which it is applied.

A number of teat dip products or mastitis control agents are available to dairy farmers which have varying degrees of effectiveness. These products or agents have in common an antimicrobial agent which is an active ingredient (usually the principal active ingredient) of the treating solution.

Numerous antimicrobial agents have been investigated, including iodophors, PVP-iodine (a particular iodophor), hypochlorites, chlorine dioxide, chlorinated isocyanurates (chlorinated-S-triazene-trione), bromine, hydroxyquinone, ammonium chloride, chlorhexidine, hexachlorophene, diaphene, cetyl pyridinium chloride, and the quaternary ammonium germicides. Of the topically applied antimicrobial agents (i.e., those agents applied directly to the skin) which have been investigated for control of bovine mastitis, iodophors, quaternary ammonium compounds, and chlorine-releasing agents (particularly sodium hypochlorite and, more recently, chlorinated isocyanurates) appear to have gained the widest acceptance among dairy farmers, despite the fact that some of the chlorine-releasing sanitizers (e.g. 4% aqueous NaOCl) can have an irritating effect upon cow teats. (The irritation can be mitigated with emollients but may still occur). Further, iodophors, have not been providing the necessary kill Teat dips of the instant invention are iodine-free.

Linear alkylbenzene sulfonates, or linear alkylbenzene sulfonic acids, (hereafter sometimes collectively referred to as “LAS”) are moderately effective bactericides, particularly in mildly acidic media. However, linear alkylbenzene sulfonic acids are generally more active against gram positive organisms such as Staphylococcus aureus than against gram negative organisms, particularly at “skin” pH, i.e., greater than 5.0. These microorganisms may have as their origin, water, soil, improperly cleaned utensils, manure, infected cows, human hands, etc. For the most part, gram positive organisms such as Staphylococcus aureus originate in mammals (including humans), while many gram negative organisms are found in the feces of animals as well as humans. “Gram positive” and “gram negative” are designations of bacteria which are well-known to one skilled in the art.

In the control of bovine mastitis, rapid killing of bacteria is essential, since prolonged treatment (e.g. more than 15 minutes or even more than a minute) with the teat dip is normally impractical. Bactericidal tests of teat dip formulas are most informative when they are conducted with a view toward measuring their short-term kill. As discussed below, the method and composition of the present invention do provide this desirable rapid kill.

For cost savings purposes, it is desirable to provide a concentrate which may be diluted by the distributor or at the farm. It is cheaper to store and transport a concentrate as compared to a ready to use solution which is heavier and takes up more volume. However, it has surprisingly been found that the effectiveness of a concentrated teat dip may suffer when the concentrate is diluted with poor quality water. The present invention provides a teat dip concentrate composition that is suitable for dilution with on-site water, no matter the grain or ppm magnesium or calcium cations and provides an effective ready to use solution capable of suitable bacterial kill to prevent mastitis and to maintain teat health.

### SUMMARY

The antimicrobial activity (e.g., biostatic and biocidal activity) against both gram positive and gram negative microorganisms (e.g., mastitis) of an aqueous anionic surfactant is significantly increased when the aqueous mixture has therein a pH maintaining agent (e.g., a buffer) which maintains the pH of the solution on the acidic side, e.g., below about 2.7. An aqueous solution of the invention composition maintained at a pH in the range of 1.0 to 3.0, in the range of 2.0 to 3.0 has been found to have optimum antimicrobial activity (and hence optimum mastitis inhibition) with tolerable, little or no irritation of the skin.

Accordingly, this invention contemplates a topically applied composition for the killing of mastitis which comprises an aqueous anionic surfactant having a composition including lactic acid, sulfonated oleic acid, sorbitol, dodecyl benzyl sulfonic acid, chelant, aesthetic improving agents, and water. The composition of the invention is provided as a concentrate that is later diluted with water. It has surprisingly been found that teat dip compositions provided as a ready to use solution may differ in performance from a concentrated composition that is diluted on site before use as compared to being prepared as a ready to use composition by the manufacturer. In an embodiment the chelant is 1-hydroxyethylidene-1 ml-diphosphonic acid. It has surprisingly been found that the combination of acidified sulfonated oleic acid and 1-hydroxyethylidene-1,1-diphosphonic acid provides superior antimicrobial performance.

Compositions of the invention are maintained at a pH in the range of 2.0 to 5.0, preferably in the range of 2.1 to 4.0 and most preferably in the range of 2.0 to 3.0. The teat dip is applied topically. Conventional teat dip ingredients can include emollients and water thickeners or thixotropes. Such conventional ingredients are added to impart desirable handling characteristics thereto.

Topical mastitis-treating compositions of this invention, according to available test results, have excellent bactericidal properties against gram negative organisms such as Pseudomonas aeruginosa, Escherichia coli (E. coli), Enterobacter aerogenese, and gram positive bacteria such as Staphylococcus aureus appear to provide relative quick bactericidal action, e.g. an effective kill in 15 to 30 seconds. Furthermore, maintenance of compositions in the preferred and most preferred pH ranges appears to provide especially good bactericidal activity against gram negative organisms and gram positive organisms while ideally not excessively irritating the bovine teat.

### DESCRIPTION

As noted previously, compositions of this invention are typically “teat dips” and will be described as such, though, of course, other methods of topical applications besides teat-dipping might be used, if equally effective in killing bacteria.

For the following defined terms, these definitions shall be applied, unless a different definition is given in the claims or elsewhere in this specification.

“Killing” as the term is used herein is meant to include actual killing as well as inhibition or abatement of microorganism growth.

The term “substantially free” may refer to any component that the composition of the invention lacks or mostly lacks. When referring to “substantially free” it is intended that the component is not intentionally added to compositions of the invention. Use of the term “substantially free” of a component allows for trace amounts of that component to be included in compositions of the invention because they are present in another component. However, it is recognized that only trace or de minimus amounts of a component will be allowed when the composition is said to be “substantially free” of that component.

All numeric values are herein assumed to be modified by the term “about,” whether or not explicitly indicated. The term “about” generally refers to a range of numbers that one of skill in the art would consider equivalent to the recited value (i.e., having the same function or result). In many instances, the terms “about” may include numbers that are rounded to the nearest significant figure.

As used in this specification and the appended claims, the singular forms “a”, “an”, and “the” include plural referents unless the content clearly dictates otherwise. Thus, for example, reference to a composition containing “a compound” includes a mixture of two or more compounds. As used in this specification and the appended claims, the term “or” is generally employed in its sense including “and/or” unless the content clearly dictates otherwise.

Weight percent, percent by weight, % by weight, and the like are synonyms that refer to the concentration of a substance as the weight of that substance divided by the weight of the composition and multiplied by 100.

Unless otherwise stated, all weight percentages provided herein reflect the active weight percent of each component. The weight percent of raw material as provided by the manufacturer is easily determined from the provided information by use of product data sheets as provided from the manufacturer.

As used herein the term, “consisting essentially of” in reference to a composition refers to the listed ingredients and does not include additional ingredients that, if present, would affect the composition. The term “consisting essentially of” may also refer to a component of the composition. As used herein the term “consisting essentially of” in reference to a method of preparing a protective coating refers to the listed steps and does not include additional steps (or ingredients if a composition is included in the method) that, if present, would substantially affect the method.

As used herein, the term “iodine-free” refers to a composition, mixture, or ingredient that does not contain an iodine or iodine-containing compound or to which an iodine or iodine-containing compound has not been added. Should an iodine or iodine-containing compound be present through contamination of an iodine-free composition, mixture, or ingredients, the amount of iodine shall be less than 0.5 wt %. More preferably, the amount of iodine is less than 0.1 wt %, and most preferably, the amount of iodine is less than 0.01 wt %.

In the interest of brevity and conciseness, any ranges of values set forth in this specification contemplate all values within the range and are to be construed as support for claims reciting any sub-ranges having endpoints which are real number values within the specified range in question. By way of a hypothetical illustrative example, a disclosure in this specification of a range of from 1 to 5 shall be considered to support claims to any of the following ranges: 1-5; 1-4; 1-3; 1-2; 2-5; 2-4; 2-3; 3-5; 3-4; and 4-5.

The anionic surfactants, buffers, emollients, and thickeners of a typical teat dip will now be described in detail.

### Biocidal Agents

Compositions of the invention include at least one carboxylic acid as a biocidal agent. In an embodiment the carboxylic acid is comprised of lactic acid or sulfonated oleic acid or a combination thereof. In an embodiment the composition includes from about 2 up to about 20 weight percent carboxylic acid. In yet another embodiment from about 1 to about 10 weight percent is comprised of lactic acid and from about 1 up to about 10 weight percent is comprised of dodecyl benzyl sulfonic acid.

### Anionic Surfactants

Anionic surfactants useful in the present invention have maximum biocidal activity and/or biostatis against mastitis-causing organisms at a pH in the range of 2.0 to 5.0 (preferably about 2.1 to 4.0 and most preferably in the range of 2.0 to 3.5). Hence, these surfactants are generally present in the present compositions in the ionized form preferably to the extent of 0.5% to 10% by weight.

Linear alkylbenzene sulfonates are a useful class of anionic surfactants which appear to provide activity against both gram positive microorganisms (e.g., S. aureus) as well as gram negative microorganisms (e.g., Pseudomonas aeruginosa) in the indicated pH ranges. While the LAS is not necessary to provide acceptable biocidal results in the composition of the invention, it does assist in keeping the composition and the use solution in a single phase. With respect to the linear alkyl chain of the LAS, it should not be so long as to create incompatibility with water yet not so short so as to reduce antimicrobial action. Therefore, the alkyl chains should preferably be 9 to 18 carbon atoms in length. All sulfonates are not equally effective at maintaining the composition in a single phase while keeping the concentration of the surfactant low enough so as not to irritate the skin. In an embodiment dodecyl benzyl sulfonic acid is used.

### Chelants

Since the present invention is a concentrated formula, the composition is not diluted at the manufacturing site. It was discovered that the efficacy of the composition was adversely affected if the dilution water used to prepare the use solutions or ready to use solutions was less than satisfactory. By less than satisfactory, it is meant that if the dilution water had high amounts of hardness ions such as magnesium, calcium and the like and the teat dip did not perform suitably.

It was surprisingly found that the addition of a chelant allowed the teat dip concentrate of the invention to perform well no matter the hardness of the dilution water. Because the concentrate composition has an acidic pH, care must be taken when selecting the chelant. It was found that hydroxyethylidene-1,1-diphosphonic acid (HEDP) functions even when the composition is acidic and allows the dilution of the concentrate with any type of water yet the diluted or ready to use solution performs as well as when the concentrate is diluted with soft water.

In an embodiment, between about 0.1 to about 5 weight percent, about 0.25 to about 4 weight percent, about 0.3 to about 3 weight percent, about 0.5 to about 2 weight percent chelant is included in the composition concentrate.

### Buffering Agents

As discussed below, the composition according to the present invention is most suitable for use as a teat dip when in the form of an aqueous solution containing a major amount of thickened water. Even if neutral, softened, distilled, or deionized water is used, adjustment of the pH of teat dip to the desired range and stabilization of the adjusted pH with a buffer are necessary. The pH of aqueous solutions of compositions according to the present invention should be in the range of 2 to 5, more preferably 2.1 to 4.0 and most preferably in the range of 2.0 to 3.5. A buffer system found to be suitable for maintaining the pH at the desired value (e.g. within about a pH unit) is a citrate-citric acid buffer. As is known in the art, the C₁₂ benzene sulfonates and the corresponding sulfonic acid are commercially available as mixtures with the C₁₄ and C₁₆ homologs and sometimes other homologs as well. The degree of purity of the C₁₂ species does not appear to be important in the context of this invention, and commercially available forms of the sulfonic acid and its salts are fairly useful, without further purification. Other potentially useful sulfur-based anionic surfactants include sulfonated oleic acid alkylsulfosuccinates, and sodium-N-methyl-N-tall oil taurate.

Although not preferred, the present invention contemplates the use of phosphorus-based anionic surfactants. For example, mono and diphosphate esters for the buffering agent used being that it be physiologically compatible with the skin, compatible with the other ingredients of the composition, and not detrimental with respect to the antibacterial efficacy of the composition. The citrate of the citric acid buffer is preferably the salt of a monovalent metal base such as an alkali metal hydroxide. To raise the pH to the desired range it may be necessary for a base, e.g., 50% aqueous NaOH, to be added.

As noted above, the presently preferred pH is below about 2.7 (determined at 20° C.). Efficacy roughly comparable to commercially available iodophor teat dips has been observed at this range of pH. Compositions buffered to the preferred and to the most preferred pH ranges exhibit even greater antimicrobial activity.

### Emollients

Emollients incorporated into compositions of the present invention can serve to assist in forming a protective coating on the skin to retain moisture. To be useful in the present invention, an emollient should have a soothing action on teat skin, should be compatible with aqueous buffered solutions of anionic surfactants, and should not significantly detract from the antimicrobial action of the anionic surfactants utilized in this invention. Liquid organic emollients (e.g. polyols with relatively high boiling points, typically above 100° C. at 1 atmosphere) are preferred, but water soluble or water dispersible solids such as polyvinyl pyrrolidone or sorbitol have been used effectively in known teat dip formulas. Sorbitol takes up moisture under some conditions and is thus believed to provide an emollient action similar to liquid polyols. The amount of the emollient in a composition suitable for use, as is, for teat dipping should be in the range of from about 30 wt.-% to about 50 wt.-%, from about 35% by weight up to 45% by weight, from about 38 weight percent up to about 42 weight percent of the total composition.

Some emollients also perform as thickening agents. An important aspect of the teat dip formula is that it is fluid enough for pouring or dipping but still has sufficient thixotropy or viscosity to resist rapid draining or running off from the teat or udder. In an embodiment, sorbitol is provided as both the emollient and the thickening agent. More than 0.1% by weight of thickener (based on the total composition) provides a thickening effect.

### Aqueous Diluent

Water is provided in the concentrate composition of the invention and is also used as the diluent to prepare the ready to use solution. Water is suitable as a diluent in compositions of this invention particularly because of its unquestionable economic advantages over other liquid diluents. The aqueous diluent used in the concentrated composition of this invention is water in an amount from about 14 weight percent up to about 67 weight percent, from about 20 weight percent up to about 60 weight percent, from about 30 weight percent up to about 50 weight percent, from about 35 weight percent up to about 45 weight percent. When preparing the concentrated composition of the invention, the manufacturer has control over the water that is used. In an embodiment softened, deionized, distilled, or neutral water is used to prepare the concentrated composition of this invention.

The water used to prepare the concentrate may be very different than the water used to prepare the ready to use solution. One will readily recognize that when providing a concentrate, the water used to dilute the concentrate to a ready to use solution is beyond the control of the manufacturer. Therefore, the concentrated composition of the invention must allow for variances in the water quality. As addressed above, the chelant included in the composition is one method of allowing for variances in the water quality of the diluent used to prepare the ready to use solution. One of ordinary skill in this art will be aware of the fact that, the pH of tap water can vary with hardness and other factors. Hard water with a pH approaching 10 is known, as is water with a pH on the slightly acid side, therefore, a well-designed buffer system and chelant must be included to provide for fluctuations in pH and hardness which might be introduced by slightly alkaline tap water.

Concentrate compositions of the invention are diluted with water in about a 1 to about 10 dilution of concentrate to water to prepare the use solution.

### Aesthetic Enhancing Agents

As is known in the art of bactericidal compositions, colorants (e.g. dyes or pigments), odorants, extenders, and other non-essential or optional ingredients can be included in teat dip formulas and this can be utilized (if desired) in compositions of this invention. Colorants are particularly desirable for aesthetic reasons and are also added for convenience in identifying a product from among a number of products which a dairy farmer may have in the milk-house. Colorants may be included in compositions of the invention in an amount up to about 0.05 weight percent, up to about 0.01 weight percent, or up to about 0.009 weight percent. Compositions of the invention may include a single colorant or a combination of colorants. Colorants useful in compositions of the invention include but are not limited to FD&C Yellow 5 and FD&C Red 40. One skilled in the art will recognize that colorants useful in preparing compositions of the invention must be GRAS for foods.

Concentrated teat dip compositions of the invention include the following components in the listed ranges:

| | Percent by | Percent by |
|---|---|---|
| Component | weight | weight |
| Lactic acid | 1-10 | 3-7 |
| Sulfonated oleic acid | 1-15% | 8-12 |
| Sorbitol | 30-50% | 35-45 |
| Dodecyl benzyl sulfonic acid | 1-10% | 3-7 |
| 1-hydroxyethylidene-1m1- | 0.1-5% | 0.5-1.5 |
| diphosphonic acid | | |
| FD&C yellow 5 | 0.01-0.1% | 0.01-0.1 |
| FD%C red 40 | 0.01-0.1% | 0.01-0.1 |
| Water | 14.8-66.9% | 30-50 |

When diluted with water the teat dip concentrate of the invention becomes a ready to use solution or a use solution having the following composition:

| | Percent by | Percent by |
|---|---|---|
| Component | weight | weight |
| Lactic acid | 0.1-5 | 0.1-1 |
| Sulfonated oleic acid | 0.1-5 | 0.1-1 |
| Sorbitol | 2-10 | 2-6 |
| Dodecyl benzyl sulfonic acid | 0.1-5 | 0.1-2.1 |
| 1-hydroxyethylidene-1m1- | 0.01-1 | 0.05-0.9 |
| diphosphonic acid | | |
| FD&C yellow 5 | 0.0001-0.1 | 0.0005-0.01 |
| FD%C red 40 | 0.0001-0.1 | 0.0005-0.01 |
| Water | 73.9-97 | 90-97 |

### Methods of Application

Compositions according to the present invention have been found to be particularly effective when used as a teat dip, though spraying or swabbing onto the teats might be expected to have somewhat similar bactericidal effects if the contact time is about the same. In an embodiment the teats of the animal are dipped in a reservoir or receptacle containing a diluted teat dip of the present invention with the excess being then allowed to drip freely when the source is removed. In another embodiment the diluted teat dip composition of the invention is sprayed onto the teats of the animal and the excess is allowed to drip freely. In yet another embodiment the diluted teat dip composition is provided as a foam and the teats are either dipped into the foamed composition or the foam is sprayed onto the teats. It is preferred that the contact time of the diluted composition (ready to use composition or use solution) is greater than a second, greater than 5 seconds, greater than 10 seconds, greater than 15 seconds and including up to 15 minutes.

In order to prepare a foam from the invention concentrate, a foaming applicator may be used. Such an applicator may be in the form of a foaming sprayer and the concentrate may be diluted before or during the foaming step depending upon the applicator.

The present invention can be better understood with reference to the following examples. These examples are intended to be representative of specific embodiments of the invention, and are not intended as limiting the scope of the invention.

### EXAMPLES

Two antimicrobial teat dip formulations were prepared. One was prepared in accordance with the present invention and included the chelant HEDP (Example) while the other did not include any chelant (Comparative Example).

| | Compar-ative | |
|---|---|---|
| Component (% w/w) | Example | Example |
| Lactic Acid | 5.0 | 5.0 |
| Sorbitol USP | 40.0 | 40.0 |
| Dodecyl benzyl | | |
| sulfonic acid | 5.0 | 5.0 |
| Sulfonated Oleic Acid | 10 | 10 |
| HEDP | — | 1.0 |
| Deionized Water | 40.0 | 39.0 |

The Example formulation and the Comparative Example concentrates were diluted in a 1:10 dilution of concentrate to water using 500 ppm synthetic hard water with 500 ppm alkalinity to prepare use solutions. Each of the use solutions were then tested for efficacy of kill using Staphylococcus aureus ATCC 6538, Escherichia coli ATCC 11229, and Enterobacter aerogenes ATCC 13048 and compared against a commercially available teat dip sold under the tradename Oxy-Gard by Ecolab Inc. located in St. Paul, Minn. S. aureus, E. coli, and E. aerogenes were chosen since they are the largest contributors to bovine mastitis.

An organic soil challenge of 10% sterile 2% fat milk was added to the culture medium along with either the Example or Comparative Example use solution (diluted concentrate). The inoculum loads shown in the table below were added to the tryptone glucose extract agar culture medium along with the organic soil challenge and held at ambient temperature (between about 20° and about 26° C.) for 15 seconds or for 30 seconds before the 9 ml Dey/Engley neutralizer was added. Neutralizer screens performed as part of the testing verified that test substances were adequately neutralized and that the neutralizer was not detrimental to the test organisms.

Inoculum Numbers (CFU/mL)

| Test System | A | B | Average |
|---|---|---|---|
| Staphylococcus aureus ATCC | 60 × 10⁶ | 79 × 10⁶ | 6.95 × 10⁷ |
| 6358 | | | |
| Escherichia coli ATCC 11229 | 100 × 10⁶ | 89 × 10⁶ | 9.45 × 10⁷ |
| Enterobacter aerogenes ATCC | 79 × 10⁶ | 76 × 10⁶ | 7.75 × 10⁷ |
| 13048 | | | |

The samples were then incubated at 35° C. for 48 hours.

The results for Staphylococcus aureus, Escherichia coli and Enterobacter aerogenes are shown in the tables below:

Staphylococcus aureus ATCC 6538

| | Organic | | | Average | Log |
|---|---|---|---|---|---|
| | Soil | Exposure | Survivors | Survivors | Reduc- |
| | Challenge | Time (sec) | (CFU/mL) | (CFU/mL) | tion |
| Comparative | 10% milk | 15 | <10, <10 | <10 | >6.84 |
| Example | | 30 | <10, <10 | <10 | >6.84 |
| Example | 10% milk | 15 | <10, <10 | <10 | >6.84 |
| | | 30 | <10, <10 | <10 | >6.84 |
| Oxy-Gard | 10% milk | 15 | 20, 6 × 10¹ | 1.30 × 10² | 5.73 |
| | | 30 | 3, 6 × 10¹ | 4.50 × 10¹ | 6.19 |

Escherichia coli ATCC 11229

| | Organic | Exposure | | Average | Log |
|---|---|---|---|---|---|
| | Soil | Time | Survivors | Survivors | Reduc- |
| | Challenge | (sec) | (CFU/mL) | (CFU/mL) | tion |
| Com- | 10% milk | 15 | 400*, 368* × 10⁵ | 3.84 × 10⁷ | 0.39 |
| parative | | 30 | 25, 46 × 10⁵ | 3.55 × 10⁶ | 1.43 |
| Example | | | | | |
| Example | 10% milk | 15 | 198, 177 × 10¹ | 1.88 × 10³ | 4.70 |
| | | 30 | 3, 4 × 10¹ | 3.50 × 10¹ | 6.43 |
| Oxy-Gard | 10% milk | 15 | 114, 29 × 10¹ | 7.15 × 10² | 5.12 |
| | | 30 | 21, 16 × 10¹ | 1.85 × 10² | 5.71 |

*Estimated count

Enterobacter aerogenes ATCC 13048

| | | Expo- | | | |
|---|---|---|---|---|---|
| | Organic | sure | | Average | Log |
| | Soil | Time | Survivors | Survivors | Reduc- |
| | Challenge | (sec) | (CFU/mL) | (CFU/mL) | tion |
| Com- | 10% milk | 15 | 175, 217 × 10⁵ | 1.96 × 10⁷ | 0.60 |
| parative | | 30 | 19, 43 × 10⁵ | 3.10 × 10⁶ | 1.40 |
| Example | | | | | |
| Example | 10% milk | 15 | <10, 22 × 10¹ | <1.15 × 10² | >5.83 |
| | | 30 | 3, 1 × 10¹ | 2.00 × 10¹ | 6.59 |
| | | 15 | 200, 261 × 10¹ | 2.31 × 10³ | 4.53 |
| Oxy-Gard | 10% milk | 30 | 4, 1 × 10¹ | 2.50 × 10¹ | 6.49 |

The Examples show that the efficacy of the invention composition (Example) with dilution water that was high in hardness and alkalinity, reflective of real world water conditions, showed a superior kill against E. coli, S. aureus and E. aerogenes, three key mastitis related microorganisms, as compared to the Comparative Example lacking the chelant. Addition of a chelant to the composition improved the efficacy of the composition as is apparent in the percent reduction of the three tested bacteria.

The invention has been described with reference to various specific and preferred embodiments and techniques. However, it should be understood that many variations and modifications may be made while remaining within the spirit and scope of the invention.

We claim:

1. A method for killing mastitis-causing gram negative organisms including Escherichia coli, Enterobacter aerogenes and gram positive organisms including Staphylococcus aureus on an animal's teats comprising the steps of:
(a) preparing a medium, the medium comprising:
between about 1 to about 10 wt.-% lactic acid,
between 5 to about 15 wt.-% sulfonated oleic acid,
between about 30 to about 50 wt.-% sorbitol,
between about 1 to about 10 wt-% dodecyl benzyl sulfonic acid,
between about 0.1 to about 5 wt-% chelant, and
between about 30 to about 68 wt. % water;
(b) diluting the medium with water to prepare a ready to use solution wherein the use solution has a pH of less than 2.7; and
(c) treating the teats of the animal with the ready to use solution formulated for a contact time between the teats and the solution of 15 seconds to 15 minutes.

2. The method of claim 1 wherein the chelant comprises hydroxyethylidene-1,1-diphosphonic acid.

3. The method of claim 1 wherein the treating step is accomplished by applying the composition to the teats of an animal.

4. The method of claim 3 wherein the applying step is done by dipping the teats into the use solution, spraying the use solution on the teats, applying a foamed solution onto the teats, or any combination thereof.

5. A concentrated composition for killing mastitis-causing gram negative organisms including Pseudomonas aeruginosa, Escherichia coli, or Klebsiella pneumoniae or gram positive organisms including Staphylococcus aureus on an animal's teats, comprising:
between about 1 to about 10 wt.-% lactic acid,
between 5 to about 15 wt.-% sulfonated oleic acid,
between about 30 to about 50 wt.-% sorbitol,
between about 1 to about 10 wt-% dodecyl benzyl sulfonic acid,
between about 0.1 to about 5 wt-% chelant, and
between about 30 to about 68 wt. % water;
wherein a 1:10 dilution of the concentrate composition with water has a pH of less than 2.7.

6. The composition of claim 5 further comprising up to about 0.5 wt.-% aesthetic enhancing agents.

7. The composition of claim 6 wherein the aesthetic enhancing agents comprise colorants or perfumes or a combination thereof.

8. The composition of claim 5 wherein the chelant consists essentially of hydroxyethylidene-1,1-diphosphonic acid.

9. A concentrated composition for killing mastitis-causing gram negative organisms including Pseudomonas aeruginosa, Escherichia coli, or Klebsiella pneumoniae or gram positive organisms including Staphylococcus aureus on an animal's teats, consisting essentially of:
between about 1 to about 10 wt.-% lactic acid,
between 5 to about 15 wt.-% sulfonated oleic acid,
between about 30 to about 50 wt.-% sorbitol,
between about 1 to about 10 wt-% dodecyl benzyl sulfonic acid,
between about 0.1 to about 5 wt-% chelant, and
between about 30 to about 68 wt. % water;

10. The composition of claim 9 further comprising up to about 0.5 wt.-% aesthetic agents.

11. The composition of claim 10 wherein the aesthetic agents comprise colorants or perfumes or a combination thereof.

12. The composition of claim 5 wherein composition is substantially free of iodine.

13. The concentrated composition of claim 9 further comprising dilution water wherein the composition of claim 10 is diluted between about 1:10 with water.

14. The composition of claim 13 wherein the diluted composition has a pH of less then 2.7.
